(19) United States
(12) Patent Application Publication
(10) Pub. No.: US 2005/0227687 A1
(43) Pub. Date: Oct. 13, 2005

(54) Method of controlling access rights in a cellular mobile radio communication system

(76) Inventor: Nicolas Drevon, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/509,852

(22) PCT Filed: Apr. 4, 2003
(86) PCT No.: PCT/FR03/01084

§ 371 Date: Sep. 30, 2004

(30) Foreign Application Priority Data
Apr. 4, 2002 (FR) 02/04212

(51) Int. Cl. H04Q 7/20

(52) U.S. Cl. 455/432.1

(57) ABSTRACT

A method of controlling access rights in a cellular mobile radio system, including transfer of roaming agreement information from a core network to a radio access network of said system, in which method said roaming agreement information is transferred independently of the management of radio access bearers at the interface between the core network and the radio access network.

The present invention relates generally to mobile radio systems.

The present invention may be applied to any mobile radio system, such as second generation systems in particular, for example systems of the Global System for Mobile communications/GSM/EDGE Radio Access Network (GSM/GERAN) type, or third generation systems, for example systems of the Universal Mobile Telecommunication System (UMTS) type. As a general rule, the above systems are covered by standards; the corresponding standards published by the corresponding standardization organizations may be consulted for more information.

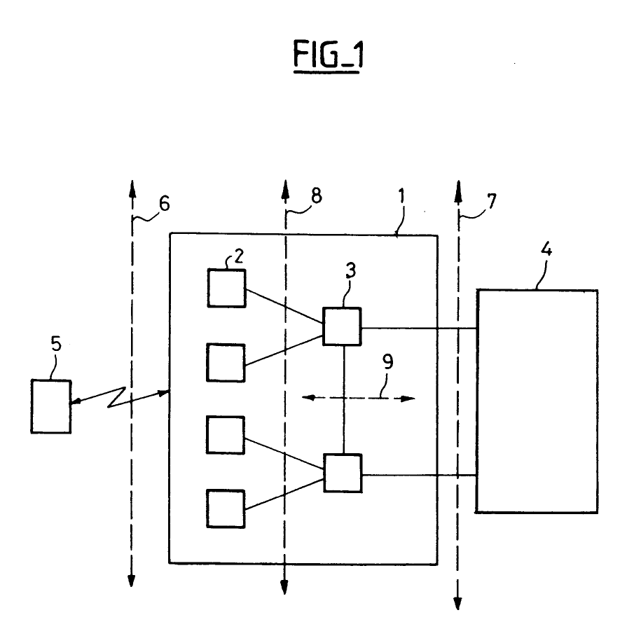

The architecture of such systems is outlined in FIG. 1. Generally speaking, this kind of system essentially comprises:
a radio access network (RAN) 1, and
a core network (CN) 4.

The radio access network is made up of base stations 2 and base station controllers 3. It communicates with mobile terminals 5 via a radio interface 6 and with the core network 4 via an interface 7. Within the radio access network, base stations communicate with base station controllers via an interface 8. The radio access network is essentially responsible for transmission over the radio interface between the network and the mobile terminals, for managing resources for transmission over this radio interface, and for managing the mobility of the mobile terminals in the radio access network.

The core network communicates with the radio access network via the interface 7 and with external networks that are not shown specifically. The core network is essentially responsible for routing and managing calls to or from mobile terminals and for managing the mobility of the mobile terminals between location areas (LA) and routing areas (RA).

In GSM/GERAN systems, the Radio access network is called the base station subsystem (BSS), base stations are called base transceiver stations (BTS), and mobile terminals are called mobile stations (MS). The core network essentially contains network entities or nodes such as in particular mobile switching centers (MSC) or second generation mobile switching center (2G-MSC) type entities and serving GPRS (general packet radio service) support node (SGSN) type entities. The radio interface is called the Um interface. The interface 7 is called the A interface to the MSC and the Gb interface to the SGSN. The interface 8 is called the Abis interface. In GERAN type systems, there is also an interface 9 between BSCs, known as the Iurg interface. The interface 7 in GERAN type systems corresponds to A and Gb interfaces identical to those used in the GSM and/or to an Iu interface identical to that used in the UMTS.

In UMTS type systems, the radio access network is called the UMTS terrestrial radio access network (UTRAN), a base station is called a Node B, base station controllers are called radio network controllers (RNC), and a mobile terminal is called a user equipment (UE). The radio interface is called the Uu interface, the interface 7 is called the Iu interface, the interface 8 is called the Iub interface, and there is also an interface 9 between radio network controllers, called the Iur interface. The core network also essentially contains network entities or nodes, such as in particular mobile switching center (MSC) or 3^{rd} generation mobile switching center (3G-MSC) type entities and serving GPRS (general packet radio service) support node SGSN type entities.

Moreover, systems such as the UMTS use the soft handover (macrodiversity transmission) technique, whereby a user equipment is connected simultaneously to a plurality of base stations, i.e. is served simultaneously by a plurality of serving cells (also known as active cells). The various Nodes B to which a user equipment is connected may or may not be controlled by the same radio network controller. If they are controlled by different radio network controllers, one of them, called the serving radio network controller (SRNC), has a control function for the call concerned, in particular the function of adding or removing serving cells. The Nodes B connected to the user equipment that are not controlled by the SRNC communicate with the SRNC via the radio network controllers that control them, called drift radio network controllers (DRNCs), via the Iur interface. Independently of the soft handover technique, it is also possible for a mobile to be connected to a Node B that is not controlled by the SRNC following a hard handover via the Iur interface. In the case of the GERAN, this is also possible following a hard handover via the Iurg interface, where there may be a serving BSC and a drift BSC, as in the UMTS.

A mobile terminal listens continuously or on demand to beacon channels associated with surrounding cells and carries out radio measurements on the beacon channels. A best cell may be chosen on the basis of these measurements either by the terminal itself or by the radio access network, in which case the terminal reports the measurement results to the network, in accordance with the mechanisms taken into consideration for choosing the best serving cell.

In mechanisms for cell selection or reselection at the initiative of the terminal, the terminal is able to tell, from information broadcast on the beacon channels, whether a new reselected cell (target cell) belongs to the same location area as the current serving cell. If so, the new cell becomes the new serving cell. If not, the terminal advises the network of this beforehand, using a location updating procedure, in order to have the user's right to access the new cell verified. In the event of a positive response from the network, the user is then registered in the new location area and the new cell becomes the new serving cell.

To extend the geographical coverage of these systems and/or the services offered, a plurality of networks or PLMNs is generally provided, usually associated with different operators. Roaming agreements may be entered into between the operators concerned, at the national and/or international level. The expression “home PLMN” (HPLMN) is generally used to designate the network to which a user subscribes and the term “visited PLMN” (VPLMN) is used to designate a network different from the HPLMN, in whose coverage the user is located, and with which the user's HPLMN has roaming agreements.

The roaming agreements may be such that access to a VPLMN is authorized for the whole of that VPLMN, in which case the expression “international roaming” is used, or restricted to certain areas of the VPLMN, in which case the expression “national roaming” is used. For example, such areas may correspond to areas in which the HPLMN does not provide radio coverage itself. This may apply in particular to geographical areas with very low traffic density or to the phase of rolling out a new generation infrastructure, such as a third generation infrastructure in particular.

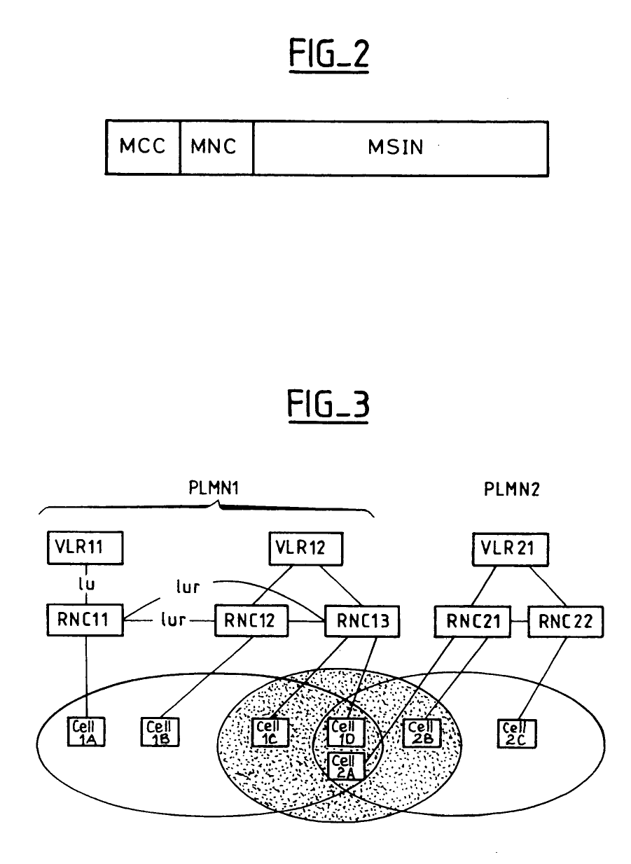

Access rights are usually controlled on the basis of user identification data, such as an international mobile subscriber identity (IMSI) number. As shown in FIG. 2, this kind of number includes a mobile country code (MCC) field identifying a country, a mobile/network code (MNC) field identifying a PLMN within that country, and a mobile subscriber identification number (MSIN) field identifying a user within that PLMN.

The access rights information is of two types:
a first type of information, referred to herein as routing agreement information, relates to applicable national and international routing agreements, identifiable from the MCC and MNC fields of the IMSI number, and
a second type of information relates to users' subscriptions, identifiable from the MSIN field of the IMSI number.

The present invention relates more particularly to controlling access rights on the basis of roaming agreements. The roaming agreement information needed for this purpose is generally not available in the terminal or in the radio access network, but is generally centralized in a routing agreement database, for example of the visitor location register (VLR) type, provided in the core network, which facilitates managing and updating this data. This kind of database may be configured with the corresponding information by operation & maintenance (O&M) means. A VLR may be linked to a MSC type entity or integrated into a SGSN type entity.

As indicated above, in mechanisms for cell selection or reselection at the initiative of the terminal, the core network is involved in choosing the target cell. Controlling rights of access to a new target cell on the basis of roaming agreements therefore does not give rise to any problems, since the routing agreement information is available in the core network (as mentioned above).

However, a problem arises with mechanisms in which the core network is not involved in choosing the target cell, that is to say with target cell selection mechanisms controlled by the radio access network, which is the case in particular with handover (intercellular transfer) mechanisms, cell change order mechanisms, and directed retry mechanisms.

Two types of solution to this problem have been proposed.

In a first type of solution, the radio access network may be configured using the roaming agreement information by operation & maintenance (O&M) means. The applicant has noted that that kind of solution is not the optimum solution, in particular because it leads to the storage of a large quantity of information in the radio access network and necessitates memory coordination in the separate O&M operations effected in the radio access network and in the core network if the objective is to align access rights control for target cell selection mechanisms in which the core network is not involved with access rights control for target cell selection mechanisms in which the core network is involved, in particular using the same location area (LA) concept in both cases.

In a second type of solution, it would be possible for the core network to communicated the roaming agreement information to the radio access network, during phases of setting up or relocating a radio access bearer (RAB) service, in particular, in a system such as the UMTS or the GSM/GERAN. The applicant has noted that that kind of solution has a number of drawbacks. It leads to the exchange of relatively long messages over the interface between the core network and the radio access network (which interface is the Iu interface in the UMTS), leading to a relatively high consumption of the resources available for transmission over this interface. Moreover, since most mobile terminals within the coverage of the same visited PLMN have the same MCC and MNC fields, the same information is then transferred many times with no benefit.

Furthermore, the applicant has also noted that another drawback of that second type of solution is the need to configure a local VLR with access rights for areas that it does not control, especially, in the case of systems like the UMTS using soft handover (macrodiversity transmission), the need to configure a local VLR with the access rights for the whole of the PLMN (and possibly for neighboring cells of neighboring PLMNS). In fact, soft handover requires the SRNC to have access rights information on cells that it does not itself control, but which are controlled by the DRNCs. The drawbacks of this include the relatively high cost in terms of the memory volume necessary in a VLR, the necessity for manual coordination of the separate O&M operations effected in each VLR, and the impossibility of using without modification a VLR already configured with such information only for the areas that it covers.

An object of the present invention is to avoid some or all of the drawbacks mentioned above. A more general object of the present invention is to optimize the control of access rights in such systems.

The present invention consists firstly in a method of controlling access rights in a cellular mobile radio system, including transfer of roaming agreement information from a core network to a radio access network of said system, in which method said roaming agreement information is transferred independently of the management of radio access bearers at the interface between the core network and the radio access network.

According to another feature, roaming agreement information transferred in this way is common to a public land mobile network identified by a subset of the international mobile subscriber identity number.

According to another feature, said subsystem includes a mobile country code (MCC) field and/or a mobile network code (MNC) field.

According to another feature, said roaming agreement information is sent at the request of the radio access network.

According to another feature, said roaming agreement information is sent on demand.

According to another feature, said roaming agreement information is sent periodically.

According to another feature, said roaming agreement information is sent in the event of an update.

According to another feature, the core network is configured beforehand with said roaming agreement information.

According to another feature, said configuration is effected by operation & maintenance (O&M) means.

According to another feature, said roaming agreement information is stored in the core network in a visitor location register (VLR) type database.

The invention also consists in a method for controlling access rights in a cellular mobile radio system, in which method, for control of access rights on the basis of roaming agreements by a first radio access network equipment, said first radio access network equipment obtains from at least one second radio access network equipment control information for at least one area not covered by said first radio access network equipment.

According to another feature, said first radio access network equipment obtains from a core network equipment that controls it control information for at least one area covered by said first radio access network equipment.

According to another feature, said second radio access network equipment obtains from a core network equipment that controls it control information for at least one area covered by said second radio access network equipment.

According to another feature, control information obtained by a radio access network equipment from a core network equipment that controls it includes roaming agreement information enabling said radio access network equipment to control access on the basis of roaming agreements for at least one area covered by said radio access network equipment.

According to another feature, said roaming agreement information is transferred to a radio access network equipment by a core network equipment that controls it using a method conforming to the first aspect of the present invention.

According to another feature, said control information obtained by said first radio access network equipment from said second radio access network equipment includes roaming agreement information enabling said first radio access network equipment to control access on the basis of roaming agreements for at least one area not covered by said first radio access network equipment.

According to another feature, said control information obtained by said first radio access network equipment from said second radio access network equipment includes information representative of control of roaming agreements by the second radio access network equipment for at least one area not covered by the first radio access network equipment.

According to another feature, said first radio access network equipment obtains control information from said second radio access network equipment via an interface connecting said radio access network equipments.

According to another feature, said first radio access network equipment obtains control information from said second radio access network equipment via the core network.

According to another feature, said first and second radio access network equipments are parts of the same network.

According to another feature, said first and second radio access network equipments are parts of adjoining networks.

According to another feature, said information representative of access control by said second radio access network equipment is obtained by said first radio access network equipment in the context of a relocation or handover procedure.

The present invention also consists in radio access network equipment comprising means adapted to implement either or both of said methods.

In particular, said radio access network equipment takes the form of a radio network controller (RNC).

The present invention further consists in core network equipment comprising means adapted to implement either or both of said methods.

In particular, said roaming agreement information being stored in a visitor location register (VLR), said core network equipment takes the form of a mobile switching center (MSC) type equipment connected to a visitor location register (VLR) or a serving GPRS support node (SGSN) type equipment integrating a visitor location register (VLR).

The present invention further consists in a mobile radio system comprising means adapted to implement a method of the above kind.

Other objects and features of the present invention will become apparent on reading the following description of one embodiment of the invention, which is given with reference to the appended drawings, in which:

FIG. 1 outlines the general architecture of a mobile radio system,

FIG. 2 outlines the structure of an IMSI number, and

FIG. 3 shows one example of a system implementing a method according to the invention.

One aspect of the invention proposes that access rights information that corresponds to semistatic information, such as roaming agreement information in particular, be transferred independently of the management of radio access bearers at the interface between the core network and the radio access network, or in other words that this information not be linked to a particular user. A radio access bearer (RAB) is a set of resources for transporting user data and signaling for a given service between a mobile terminal and the core network. Signaling exchanged at the Iu interface between the core network and the radio access network includes in particular signaling relating to radio access bearer management (in particular during phases of setting up or relocating a radio access bearer).

In particular, the present invention proposes that transferred roaming agreement information be common to a subset of the international mobile subscriber identity (IMSI) number, in particular a subset including the mobile country code (MCC) field and/or the mobile network code (MNC) field.

The quantity of data needed to transfer such information from the core network to the radio access network and the memory space needed to store this information in a VLR may therefore be significantly reduced.

Said routing agreement information transferred to a radio access network equipment may indicate, for each area covered by that equipment (for example a location area (LA)), if it is authorized or prohibited for a set of subscribers identified by the same subset of their IMSI member.

The roaming agreement information may be transferred at the request of the radio access network. It may be sent periodically or only in the event of updating.

For example, the information transferred in this way may be sent after commissioning a new node of the core network or an adjoining RNC, after setting up again a physical or virtual connection with one of said nodes, or on each modification of the roaming agreements in the core network or in an adjoining RNC.

Another aspect of the present invention proposes that a radio access network entity (such as an RNC type entity in particular) should obtain this roaming agreement information for areas that it covers from a core network entity that controls it (such as an MSC/VLR or SGSN type entity in particular) and should obtain such roaming agreement information for areas that it does not cover from other radio access network entities (which other radio access network entities themselves obtain this information from core network entities that control them). In this way the volume of information to be stored in a VLR may be significantly reduced, since it is sufficient to configure a VLR with routing agreement information for the areas that it covers, rather than for all the areas covered by the PLMN concerned. In other words, a VLR already configured with such information may be used for this kind of mechanism for controlling access to a target cell without changing it in any way.

The roaming agreement information transferred to a radio access network equipment in this way may optionally further include roaming agreement information relating to adjoining cells belonging to at least one adjoining PLMN with which the PLMN concerned has roaming agreements.

Another option, when there is no Iur interface with an adjoining radio access network equipment that may in particular belong to an adjoining PLMN, and in the case of a mechanism employing a relocation (change of serving RNC) procedure in the case of the UMTS or a handover procedure in the case of the GSM/GERAN or of UMTS-GSM interworking, is to have the access rights checked by the target radio access network equipment on the basis of the IMSI number.

Generally speaking, and to group the various possibilities together a common definition, another aspect of the invention relates to a method in which, for access rights control based on roaming agreements by a first radio access network equipment, said first radio access network equipment obtains from at least one second radio access network equipment control information for at least one area not covered by said first radio access network equipment.

Said first radio access network equipment advantageously obtains from a core network equipment that controls it control information for at least one area covered by said first radio access network equipment.

Said second radio access network equipment advantageously obtains from a core network equipment that controls it control information for at least one area covered by said second radio access network equipment.

In particular, the control information obtained by a radio access network equipment from a core network equipment that controls it includes roaming agreement information enabling said radio access network equipment to control access on the basis of roaming agreements for at least one area covered by said radio access network equipment.

Said roaming agreement information is advantageously transferred to a radio access network equipment by a core network equipment that controls it using a method conforming to the first aspect of the present invention.

One possibility is for said control information obtained by said first radio access network equipment from said second radio access network equipment to include roaming agreement information enabling said first radio access equipment to control access on the basis of roaming agreements for at least one area not covered by said first radio access network equipment.

Another possibility is for said control information obtained by said first radio access network equipment from said second radio access network equipment to include information representative of control of roaming agreement by said second radio access network equipment for at least one area not covered by the first radio access network equipment.

One possibility is for said first radio access network equipment to obtain control information from said second radio access control equipment via an interface connecting said radio access network equipments.

Another possibility is for said first radio access network equipment to obtain control information from said second radio access network equipment via the core network.

One possibility is for said first and second radio access network equipments to be parts of the same network.

Another possibility is for said first and second radio access network equipments to be parts of adjoining networks.

Said information representative of access control by said second radio access network equipment is advantageously obtained by said first radio access network equipment in the context of a relocation procedure in the case of the UMTS or a handover procedure in the case of the GSM/GERAN and of UMTS-GSM interworking.

FIG. 3 shows one example of a system able to implement a method of the invention.

FIG. 3 shows, by way of example:
cells 1A, 1B, 1C, 1D belonging to a first public land mobile network PLMN1 and cells 2A, 2B, 2C belonging to a second public land mobile network PLMN2,
radio access network equipments, in this instance radio network controller (RNC) type equipments, for example a radio network controller RNC11 controlling the cell 1A, a radio network controller RNC12 controlling the cell 1B, a radio network controller RNC13 controlling the cells 1C and 1D, a radio network controller RNC21 controlling the cells 2A and 2B, and a radio network controller RNC22 controlling the cell 2C,
visitor location register (VLR) type equipments in the core network, for example a visitor location register VLR11 controlling the radio network controller RNC11, a visitor location register VLR12 controlling the radio network controllers RNC12 and RNC13, and a visitor location register VLR21 controlling the radio network controllers RNC21 and RNC22.

FIG. 3 relates, by way of example, to the situation in which a target cell selection mechanism controlled by the radio access network is executed from a serving cell consisting of the cell 1D, the target cell being chosen from among the cells adjoining the cell 1D, including the cells 1C, 2A, 2B. In this example, the serving RNC (RNC13) controlling the serving cell 1D then contains information necessary for controlling access rights to one or the other of the cells 1C, 2A, 2B.

According to the invention, in this example, the radio network controller RNC13 obtains from the visitor location register VLR12:
roaming agreement information for the areas covered by the radio network controller RNC13 (including the cell 1C), and
optionally, roaming agreement information for the cells 2A and cell 2B that are not covered by the radio network controller RNC13 but correspond to adjoining cells belonging to an adjoining PLMN (PLMN2) with which PLMN1 has roaming agreements.

Another possibility, if there is no interface Iur with an adjoining RNC (such as the radio network controller RNC21 in this example) that may in particular belong to an adjoining PLMN, and in the case of a mechanism implementing a relocation procedure (or change of serving RNC, from RNC13 to RNC21 in this example), or inter-RNC handover (from RNC13 to RNC21 in this example), is to have access rights controlled by the target RNC (RNC21 in this example) on the basis of the IMSI number, and to send to the source RNC (RNC13 in this example) information representative of access rights control by the target RNC.

As is known in the art, the relocation procedure comprises the following exchanges of messages:
a “Relocation Required” message is sent from the source RNC (RNC13 in this example) to the CN,
a “Relocation Request” message is sent from the CN to the target RNC (RNC21 in this example) to the CN,
a “Relocation Request Acknowledgement” message is sent from the target RNC (RNC21 in this example) to the CN, and
a “Relocation Command” message is sent from the CN to the source RNC (RNC13 in this example).

The present invention proposes that information representative of access rights control by the target RNC be included in the “Relocation Request Acknowledgement” message sent from the target RNC to the CN and in the “Relocation Command” message sent from the CN to the source RNC.

Furthermore, for soft handover or hard handover via the interface Iur, for which the radio network controller RNC13 would have a serving RNC role, as well as for relocation or handover via the core network, the radio network controller RNC13 would obtain from the radio network controller RNC12 roaming agreement information for areas covered by RNC12, and where applicable its neighbors.

Furthermore, for soft handover or hard handover via the interface Iur, for which the radio network controller RNC13 would have a serving RNC role, as well for relocation or handover via the core network, the radio network controller RNC13 would obtain from the radio network controller RNC11 roaming agreement information for areas covered by RNC11, and where applicable its neighbors.

The same principles may be applied to any RNC other than the radio network controller RNC13 referred to by way of example hereinabove.

For example, to illustrate the transfer of roaming agreements between the core network and a radio network controller and between two radio network controllers, it is possible to use the mechanisms of the “Information Exchange Initiation” and “Information Reporting” procedures known in the art, which use the Iur interface and may be introduced over the Iu interface.

As is known in the art, the “Information Exchange Initiation” procedure includes the following exchanges of messages:
an “Information Exchange Initiation Request” message is sent from the radio network controller RNC11, for example, to the radio network controller RNC12, for example, and
an “Information Exchange Initiation Response” message is sent from the radio network controller RNC12 to the radio network controller RNC11 by way of response.

In the manner known in the art, the “Information Reporting” procedure includes the “Information Report” message transmitted from the radio network controller RNC12 to the radio network controller RNC11, for example.

The “Information Exchange Initiation” and “Information Reporting” procedures may be extended over the Iu interface in the following manner, for example:

The “Information Exchange Initiation” procedure includes the following exchanges of messages:
an “Information Exchange Initiation Request” message is sent from an RNC to a core network node, and
an “Information Exchange Initiation Response” message is sent from a core network node to the RNC by way of response.

In the manner known in the art, the “Information Reporting” procedure includes the “Information Report” message sent from the core network to the RNC.

The example shown in FIG. 3 corresponds more particularly to the UMTS (respectively GERAN), in which exchanges between VLR and RNC (respectively BSC) are effected via the Iu (respectively A or Iu) interface and exchanges between RNCs are effected via the Iur (respectively Iug) interface.

Of course, the present invention is not limited to the examples previously described and other examples that would not depart from the scope of the invention would of course be possible. Furthermore, FIG. 3 merely shows in diagrammatic form one example of a system in which a method according to the invention may be implemented, without going into the detail of the transmission and signaling methods or protocols, which may use principles that are conventional in these systems.

Over and above an access rights control method described hereinabove, the present invention further consists in a mobile radio system, a radio access network equipment, and a core network equipment all including means adapted to implement a method according to the invention. Such means may operate in accordance with the method described above; their particular implementation representing no particular difficulty for the person skilled in the art, such means do not need to be described here in more detail than by stating their function, as above.

The advantages of the present invention include in particular:
no changes are necessary in the routing tables in the VLR,
coordination between VLRs is automatic,
updating in the UTRAN is automatic if a modification is effected in any VLR of a PLMN,
updating of the radio network subsystem (RNS) tables is automatic if a new RNC is added to the UTRAN,
the quantity of data transferred from the CN is minimized, and
semistatic information is no long transferred via messages linked to calls or to UEs.

1. A method of controlling access rights in a cellular mobile radio system, including transfer of roaming agreement information from a core network to a radio access network of said system, in which method said roaming agreement information is transferred independently of the management of radio access bearers at the interface between the core network and the radio access network.

2. A method according to claim 1, wherein roaming agreement information transferred in this way is common to a public land mobile network (PLMN) identified by a subset of the international mobile subscriber identity (IMSI) number.

3. A method according to claim 2, wherein said subsystem includes a mobile country code field (MCC) and a mobile network code (MNC) field.

4. A method according to claim 1, wherein according to said roaming agreements access to a visited public land mobile network (VPLMN) is authorized for the whole PLMN or limited to certain areas of said VPLMN.

5. A method according to claim 4, wherein said areas of said VPLMN are areas in which the home public land mobile network (HPLMN) does not itself provide radio coverage.

6. A method according to claim 1, wherein the routing agreement information transferred is indicated for each location area (LA).

7. A method according to claim 1, wherein said roaming agreement information is transferred in the event of modification of said information in the core network.

8. A method according to claim 1, wherein the core network is configured beforehand with said roaming agreement information.

9. A method according to claim 8, wherein said configuration is effected by operation & maintenance (O&M) means.

10. A method according to claim 1, wherein said roaming agreement information is stored in the core network in a database of the visitor location register (VLR) type.

11. Radio access network equipment comprising means adapted to implement a method according to any one of claims 1 to 10.

12. Radio access network equipment according to claim 11 taking the form of a radio network controller (RNC).

13. Core network equipment comprising means adapted to implement a method according to claim 1.

14. Core network equipment according to claim 13, wherein, said roaming agreement information being stored in a visitor location register (VLR), said core network equipment takes the form of a mobile switching center (MSC) type equipment connected to a visitor location register (VLR).

15. Core network equipment according to claim 14, wherein, said roaming agreement information being stored in a visitor location register (VLR), said core network equipment takes the form of a serving GPRS support node (SGSN) type equipment integrating a visitor location register (VLR).

16. A mobile radio system comprising means adapted to implement a method according to claim 1.
